(19) United States
(12) Patent Application Publication
(10) Pub. No.: US 2011/0050857 A1
(43) Pub. Date: Mar. 3, 2011

(54) APPARATUS AND METHOD FOR DISPLAYING 3D IMAGE IN 3D IMAGE SYSTEM

(75) Inventors: Gwang-Soon LEE, Daejeon (KR); Youngsoo PARK, Jeonbuk (KR); Namho HUR, Daejeon (KR); Hyun LEE, Daejeon (KR); Bong-Ho LEE, Daejeon (KR); Kug-Jin YUN, Daejeon (KR); Kwanghee JUNG, Gyeonggi-do (KR); Soo-In LEE, Daejeon (KR); Jin-Woong KIM, Daejeon (KR)

(73) Assignee: Electronics and Telecommunications Research Institute, Daejeon (KR)

(21) Appl. No.: 12/874,834

(22) Filed: Sep. 2, 2010

(30) Foreign Application Priority Data
Sep. 3, 2009 (KR) 10-2009-0083215
Dec. 21, 2009 (KR) 10-2009-0128511
Aug. 20, 2010 (KR) 10-2010-0080727

(51) Int. Cl. H04N 13/02

(52) U.S. Cl. 348/47; 348/E13.074

(57) ABSTRACT

Disclosed is an apparatus and a method for displaying 3D images, which do not need to be reversed, so that users can watch the 3D images without modification in a 3D image system. The 3D images display extracts characteristic information regarding a plurality of imaging devices from left and right images taken by the imaging devices, selects an image among the left and right images, determines a reference element in the selected image, determines a selection element corresponding to the reference element in the non-selected image; calculates a disparity value between the left and right images by using the reference element and the selection element, determines whether the left and right images are normal or not by using the disparity value, and corrects the left and right images based on the determination result.

### CROSS-REFERENCES TO RELATED APPLICATIONS

The present application claims priority of Korean Patent Application Nos. 10-2009-0083215, 10-2009-0128511, and 10-2010-0080727 filed on Sep. 3, 2009, Dec. 21, 2009, and Aug. 20, 2010, respectively, which are incorporated herein by reference in their entirety.

### BACKGROUND OF THE INVENTION

1. Field of the Invention

Exemplary embodiments of the present invention relate to a 3D image system; and, more particularly, to an apparatus and a method for displaying 3D images, which do not need to be reversed, so that users can watch the 3D images without modification.

2. Description of Related Art

3D images can be defined from two points of view. Firstly, 3D images are constructed using depth information so that watchers feel as if objects in the images move away from the screen and approach them. As used herein, the depth information refers to information regarding the distance of objects relative to a reference point in 2D images. Therefore, 2D images can be rendered 3D using the depth information. Secondly, 3D images basically provide watchers with various views to provide realistic appearance.

Such 3D images are more realistic and closer to our daily experiences than 2D images so that they are increasingly being needed and used in various fields, such as broadcasting, medical care, education, military, gaming, and animation. For these reasons, various methods for reproducing 3D images are being studied.

In order to have the perception of depth from 3D images, watchers need at least two images, i.e. left and right images, which are supposed to be incident on their left and right eyes, respectively.

However, if the left and right images are erroneously incident on the right and left eyes, respectively, watchers cannot correctly recognize 3D images, not to mention the perception of depth. Such reversing of left and right images may occur during storage, distribution, transmission, or reproduction of 3D images.

Therefore, there is a need for a detailed scheme for correcting errors of 3D images, which may occur during storage, distribution, transmission, or reproduction of the 3D images, so that correct 3D images are displayed to watchers.

### SUMMARY OF THE INVENTION

An embodiment of the present invention is directed to an apparatus and a method for displaying 3D images in a 3D image system.

Another embodiment of the present invention is directed to an apparatus and a method for determining whether a 3D image is normal or not, e.g. whether left and right images of the 3D image are reversed or not, so that 3D images are displayed correctly.

Another embodiment of the present invention is directed to an apparatus and a method for determining whether 3D images are reversed or not and automatically correcting the 3D images, when reversed, so that watchers have the perception of depth from correctly displayed 3D images.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a 3D image display apparatus in a 3D image system includes: a receiving unit configured to receive left and right images taken by a plurality of imaging devices; a calculation unit configured to select an image among the left and right images, determine a reference element in the selected image, determine a selection element corresponding to the reference element in the non-selected image, and calculate a disparity value between the left and right images by using the reference element and the selection element; a determination unit configured to determine whether the left and right images are normal or not by using the disparity value; and a correction unit configured to correct the left and right images based on the determination result.

In accordance with another embodiment of the present invention, a 3D image display method in a 3D image system includes: selecting an image among left and right images taken by the imaging devices; determining a reference element in the selected image, and determining a selection element corresponding to the reference element in the non-selected image; calculating a disparity value between the left and right images by using the reference element and the selection element; determining whether the left and right images are normal or not by using the disparity value; and correcting the left and right images based on the determination result.

### BRIEF DESCRIPTION OF THE DRAWINGS

FIG. 1 illustrates the schematic structure of an apparatus for displaying 3D images in a 3D image system in accordance with an embodiment of the present invention.

FIG. 2 illustrates rectification of left and right images by an apparatus for displaying 3D images in a 3D image system in accordance with an embodiment of the present invention.

FIG. 3 illustrates a process of dividing an image by an apparatus for displaying 3D images in a 3D image system in accordance with an embodiment of the present invention.

FIGS. 4A and 4B schematically illustrate a process of selecting a selection element by an apparatus for displaying 3D images in a 3D image system in accordance with an embodiment of the present invention.

FIGS. 5A and 5B illustrate a process of determining whether a 3D image is reversed or not by an apparatus for displaying 3D images in a 3D image system in accordance with an embodiment of the present invention.

FIG. 6 schematically illustrates a process of displaying a 3D image by an apparatus for displaying 3D images in a 3D image system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

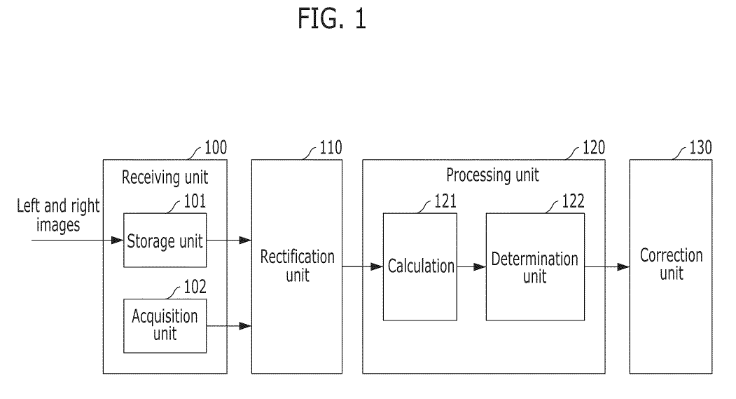

The present invention proposes an apparatus and a method for displaying 3D images in a 3D image system. The apparatus for displaying 3D images refers to a video device for reproducing 3D images, such as a 3D video multiplexer. For convenience of description, the video device will hereinafter be referred to as a 3D image display apparatus. In accordance with an embodiment of the present invention, described later, it is determined whether a 3D image is normal or not, e.g. whether left and right images of the 3D image are reversed or not, in a 3D image system and, based on the determination result, reversing of the 3D image is automatically corrected so that the watcher has the perception of depth from the correctly displayed 3D image. An apparatus for displaying 3D images in a 3D image system in accordance with an embodiment of the present invention will now be described in more detail with reference to FIG. 1.

FIG. 1 illustrates the schematic structure of an apparatus for displaying 3D images in a 3D image system in accordance with an embodiment of the present invention.

Referring to FIG. 1, the apparatus for displaying 3D images include a receiving unit 100, a rectification unit 110, a processing unit 120, and a correction unit 130. The receiving unit 100 includes a storage unit 101 and an acquisition unit 102. The processing unit 120 includes a calculation unit 121 and a determination unit 122.

The storage unit 101 is configured to receive and store left and right images taken by a plurality of imaging devices e.g. cameras. The left and right images may be taken not only by cameras, but also by other types of various imaging devices. The acquisition unit 102 acquires the characteristic information of the imaging devices, which take the left and right images, from the left and right images. Herein, the acquisition unit 102 can acquire characteristic information by extracting the characteristic information not only using the horizontal disparity of the left and right images, but also using various types of algorithms other than the horizontal disparity-based algorithm. In addition, the acquisition unit 102 can acquire the characteristic information of the imaging devices, which take the left and right images, in additional information, when the receiving unit 100 separately receives the additional information regarding camera characteristics, etc. from an outside to obtain information regarding the cameras. Herein, the characteristic information is information indicating characteristic about a type, etc of the imaging devices e.g. cameras, which take the left and right images.

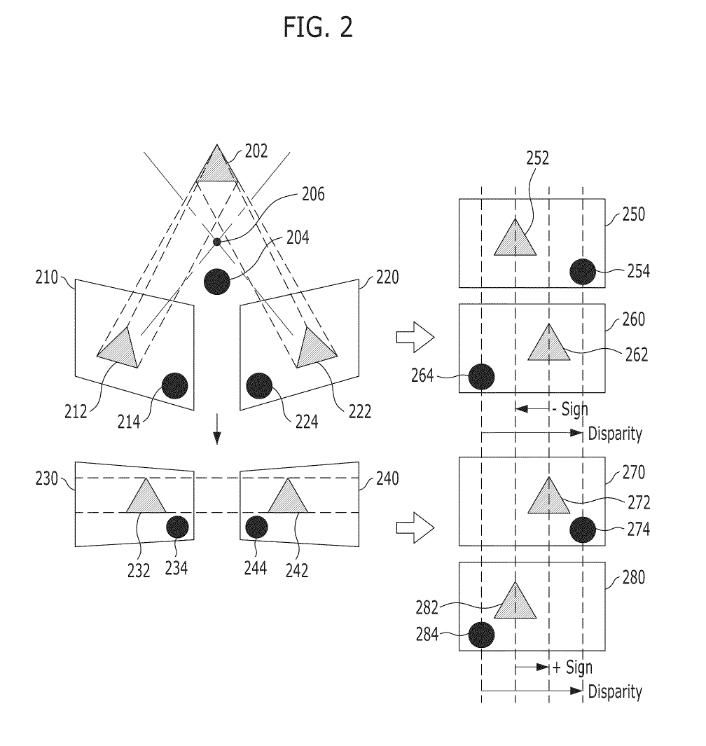

The rectification unit 110 is configured to receive left and right images from the storage unit 101 and receive the characteristic information from the acquisition unit 102. The rectification unit 110 is configured to rectify the left and right images using the characteristic information acquired by the acquisition unit 102. More specifically, the rectification unit 110 determines whether to perform rectification or not based on characteristic information regarding the cameras used to take the left and right images. For example, if it is confirmed based on the characteristic information that the left and right images have been taken by parallel-axis cameras or horizontal-axis cameras, the rectification unit 110 is not configured to rectify the left and right images. If it is confirmed based on the characteristic information that the left and right images have been taken by cross-axis cameras, the rectification unit 110 is configured to rectify the left and right images using a rectification algorithm, e.g. a homography algorithm, an affine algorithm, etc. In other words, the rectification unit 110 determines whether the left and right images have been taken by cross-axis cameras or not based on the characteristic information and, based on the determination result, rectifies the left and right images. Rectification of left and right images of a 3D image taken by cross-axis cameras in a 3D image system will now be described in more detail with reference to FIG. 2. And, when cameras taken the left and right images are the cross-axis cameras, rectification of the left and right images proceed, therefore the exemplary embodiments of the present invention will be described below when the cross-axis cameras take the left and right images.

FIG. 2 illustrates rectification of left and right images by an apparatus for displaying 3D images in a 3D image system in accordance with an embodiment of the present invention.

Referring to FIG. 2, the cross-axis cameras take images of a triangle 202 and a circle 204 and output left and right images 210 and 220 of the triangle 202 and the circle 204. In this case, the point of intersection of axes extending from center points of the cross-axis cameras, which take images of the circle 202 and the triangle 204, is defined as the point of convergence 206. When an object lying farther than the point of convergence 206, e.g. the triangle 202, is displayed through a 3D monitor, the triangle 202 appears as triangles 212, 222 positioned in the outside on the screen. On the contrary, an object lying closer than the point of convergence, i.e. the circle 204, appears as triangles 214, 224 positioned in the inside on the screen.

When the calculation unit 121 calculates the disparity value based on left and right images, the left and right images 210 and 220 serve as left and right images 250 and 260 for disparity value calculation. The triangles 252 in the left and right images 250 and 260 for disparity value calculation have negative disparity values, while the circles 254 have positive disparity values. This causes errors by disparity values when the determination unit 122 determines whether the 3D image is normal or not, e.g. whether the 3D image is reversed or not. Therefore, in order to correctly determine whether the 3D image is normal or not, the left and right images 210 and 220 need to be rectified by the rectification unit 110 so that the triangles 252 and circles 254 in the left and right images 250 and 260 for disparity value calculation have positive disparity values.

Specifically, the rectification unit 110 rectifies the left and right images 210 and 220 using a rectification algorithm, e.g. homography algorithm or affine algorithm, etc, so that the left and right images 210 and 220 become rectified left and right images 230 and 240. Herein, triangles 232, 242 and circles 234, 244 in the left and right images 230 and 240 become rectified, so that the triangles 232, 242 and circles 234, 244 have positive disparity values. The rectified left and right images 230 and 240 then serve as left and right images 270 and 280 for disparity value calculation by the calculation unit 121. The triangles 272 and 282 and the circles 274 and 284 in the left and right images 270 and 280 for disparity value calculation have positive disparity values, so that the determination unit 122 can accurately determine whether the 3D image is normal or not.

As such, in order to guarantee that the determination unit 122 correctly determine whether left and right images of a 3D image are reversed or not using the sign of disparity values, the rectification unit 110 projects left and right images 210 and 220 taken by cross-axis cameras onto two parallel planes so that the images are rectified. That is, by projecting the taken left and right images 210 and 220 onto two parallel planes, the rectification unit 110 rectifies the images so that the resulting rectified left and right images 230 and 240 are the same as images taken by cameras positioned on parallel axes. Therefore, the taken left and right images 210 and 220 are displayed as the rectified left and right images 230 and 240 by rectification of the rectification unit 110.

Based on characteristics between the left and right images, e.g. disparity value, the determination unit 122 determines whether they are reversed or not, and the calculation unit 120 calculates the disparity value between the left and right images. In order to calculate the disparity value, the calculation unit 121 selects an image between the left and right images, i.e. the calculation unit 121 selects the left or right image. And the calculation unit 121 selects a reference element in the selected image, and then designates a selection element, which corresponds to the reference element, in the non-selected image. Herein, the left and right images, which are used to the calculation unit 121 in order to calculate the disparity value, are the rectified left and right images 230 and 240 by rectification of the rectification unit 110.

For example, when the calculation unit 121 selects the right image among the left and right images, the calculation unit 121 determines the reference element in the right image, and determines the selection element in the left image. As used herein, the reference element refers to at least one pixel selected from the group consisting of a pixel corresponding to a partial region of a M×N block or a circle, for example, a pixel chosen by a predetermined criterion, and a pixel chosen randomly, wherein M and N refer to the horizontal and vertical sizes of the pixels, respectively.

The calculation unit 121 designates the selection element, which corresponds to the reference element, in the left image. As used herein, the selection element refers to a pixel in the left image, which has not been selected, corresponding to the pixel of the reference element in the selected right image. That is, the pixel of the reference element in the selected right image corresponds to the pixel of the selection element in the non-selected left image. And the calculation unit 121 calculates the disparity value between the right and left images by using the reference element and the selection element.

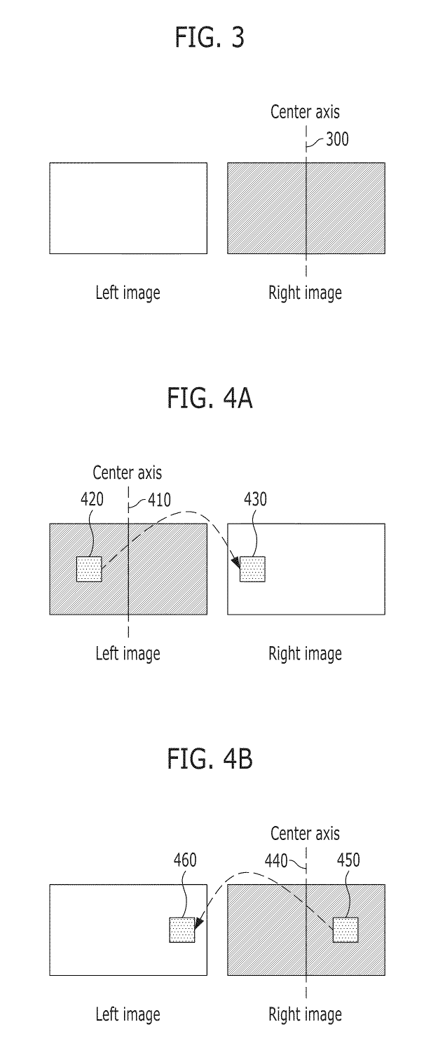

Also the calculation unit 121 can divide the selected image, and determine the reference element in the divided images, determine the selection element in the non-selected image, and then calculate the disparity value between the right and left images by using the reference element and the selection element. That is, in order to calculate the disparity value, the calculation unit 121 selects an image between the left and right images, i.e. the calculation unit 121 selects the left or right image. And then, the calculation unit 121 divides the selected image, e.g. left or right image, with reference to its center axis. The process of dividing an image by the calculation unit 121 will now be described in more detail with reference to FIG. 3.

FIG. 3 illustrates a process of dividing an image by an apparatus for displaying 3D images in a 3D image system in accordance with an embodiment of the present invention.

Referring to FIG. 3, the calculation unit 121 selects an image, which is to be divided, from left and right images. Herein, the left and right images, which are used to the calculation unit 121 in order to calculate the disparity value, are the rectified left and right images 230 and 240 by rectification of the rectification unit 110. It will be assumed for convenience of description that the right image is selected.

And, the calculation unit 121 determines a center axis 300, which vertically extends through the horizontal center of the selected image, e.g. a right image, and divides the right image with reference to the center axis 300. Besides the above-mentioned manner of dividing the image, the calculation unit 121 may employ an alternative process of, for example, dividing the image with reference to a center axis, at which both images have zero disparity. Herein, the calculation unit 121 divides the selected image in order to easily calculate the disparity values. Specifically, the calculation unit 121 secures a search region for easily selecting elements having large disparity values by dividing the selected image.

This is based on the finding that, in the case of 3DTV camera photography, the point of convergence is generally positioned at the center of the screen, in accordance with the point of convergence is positioned at the center of the screen, it is existed objects having large disparity values in the left and right with reference to the point of convergence. Therefore, the calculation unit 121 determines the center axis 300, which vertically extends through the horizontal center of the selected image, e.g. a right image, and divides the right image with reference to the center axis 300.

And, the calculation unit 121 selects a separate image among the plurality of separate images obtained by dividing the right image, e.g. selects a separate image between first and second separate images. The calculation unit 121 then determines the reference element in the selected separate image. As used herein, the reference element refers to at least one pixel selected from the group consisting of a pixel corresponding to a partial region of a M×N block or a circle, for example, a pixel chosen by a predetermined criterion, and a pixel chosen randomly, wherein M and N refer to the horizontal and vertical sizes of the pixels, respectively.

Also, the calculation unit 121 determines the selection element, which corresponds to the reference element, in the non-selected image, i.e. the left image. As used herein, the selection element refers to a pixel in the left image corresponding to the pixel of the reference element in the separate image. That is, the pixel of the reference element in the selected right image corresponds to the pixel of the selection element in the non-selected left image. The calculation unit 121 calculates the disparity value between the left and right images using the reference element and the selection element. The process of determining the selection element, which corresponds to the reference element, will now be described in more detail with reference to FIGS. 4A and 4B.

FIGS. 4A and 4B schematically illustrate a process of determining a selection element by an apparatus for displaying 3D images in a 3D image system in accordance with an embodiment of the present invention. Specifically, FIG. 4A shows a process of selecting the left image, and determining the selection element, which corresponds to the reference element, in non-selected right image, and FIG. 4B shows a process of selecting the right image, and determining the selection element, which corresponds to the reference element, in non-selected left image.

Referring to FIG. 4A, the calculation unit 121 selects an image (e.g. left image) among the left and right images. The calculation unit 121 determines a reference element 420 in the selected left image, and determines a selection element 430, which corresponds to the reference element 420, in the non-selected right image. Herein, the calculation unit 121 determines the selection element 430 based on an algorithm such as Sum of Squared Differences (SSD) for analyzing the brightness difference between pixels, Sum of Absolute Differences (SAD), or Normalized Cross Correlation (NCC) for analyzing cross correlation. And then the calculation unit 121 calculates the disparity value between the reference element 420 and the selection element 430.

Also as above-described, the calculation unit 121 can divide the selected image, determine the reference element 420 in the divided images, and then determine the selection element 430 corresponding to the reference element 420 in the non-selected image. That is, the calculation unit 121 selects an image, e.g. left image, among the left and right images. The calculation unit 121 divides the selected left image with reference to the center axis 410 into first and second separate images. The calculation unit 121 determines the reference element 420 in a separate image, e.g. the first separate image among the separate images, and determines the selection element 430, which corresponds to the reference element 420, in the non-selected right image. Herein, the calculation unit 121 determines the selection element 430 based on an algorithm such as Sum of Squared Differences (SSD) for analyzing the brightness difference between pixels, Sum of Absolute Differences (SAD), or Normalized Cross Correlation (NCC) for analyzing cross correlation. And then the calculation unit 121 calculates the disparity value between the reference element 420 and the selection element 430.

The calculation unit 121 does not consider the vertical disparity between the left and right images, but the horizontal disparity only, to calculate the disparity value. Assuming that the disparity value is D, the horizontal coordinate of the reference element 420 is Sx, and the horizontal coordinate of the selection element 430 corresponding to the reference element is Cx, the calculation unit 121 calculates the difference (Sx−Cx) between the horizontal coordinates of the left and right images as the disparity value (D).

For example, to be more specific, the calculation unit 121 determines the reference element 420 in the selected left image or the separate images of the selected left image, determines the selection element 430 corresponding to the reference element 420 in the non-selected right image, and then calculates the disparity value between the left and right images by using the reference element 420 and the selection element 430. Assuming that the horizontal coordinate of the reference element 420 is Lx and the horizontal coordinate of the selection element 430 is Rx, the disparity value is: D=Lx−Rx.

Besides the above-described manner, the calculation unit 121 may calculate the disparity value in an alternative manner. For example, the calculation unit 121 calculates the global disparity value between the reference element 420 and the selection element 430 a plurality of times using a binocular disparity model, and adopts the calculated global disparity value as the disparity value. Alternatively, the calculation unit 121 aligns the reference element 420 with the selection element 430, averages the disparity values of respective pixels inside the aligned elements, and adopts the average as the disparity value. Alternatively, the calculation unit 121 aligns the reference element 420 with the selection element 430, selects a pixel lying at the center of the aligned elements, calculates the disparity between the selected pixel and other pixels, and adopts the calculated disparity as the disparity value.

As such, the calculation unit 121 calculates the disparity value in the above-mentioned manners and, in order to obtain a more precise disparity value, the calculation unit 121 calculates disparity values with regard to a number of reference elements inside an image frame or over a number of frames for a predetermined period of time, and obtains the final disparity value through statistical analysis of the calculated disparity values. The obtained disparity value has a size or sign (±), so that the determination unit 122 identifies the disparity value with regard to a predetermined reference value to determine whether the 3D image is reversed or not. The reference value varies according to whether the reference element exists in the left or right image.

Referring to FIG. 4B, the calculation unit 121 selects an image (e.g. right image), among the left and right images. The calculation unit 121 determines a reference element 450 in the selected right image. Herein, the calculation unit 121 can divide the selected right image with reference to the center axis 440 into first and second separate images, and then determine the reference element 450 in a separate image, e.g. the second separate image among the separate images.

This way, the calculation unit 121 determines the reference element 450 in the selected right image or the divided second separate image, and then determines a selection element 460, which corresponds to the reference element 450, in the non-selected left image. Herein, the calculation unit 121 determines the selection element 460 based on an algorithm such as Sum of Squared Differences (SSD) for analyzing the brightness difference between pixels, Sum of Absolute Differences (SAD), or Normalized Cross Correlation (NCC) for analyzing cross correlation. And then the calculation unit 121 calculates the disparity value between the reference element 450 and the selection element 460.

The calculation unit 121 does not consider the vertical disparity between the left and right images, but the horizontal disparity only, to calculate the disparity value. Assuming that the disparity value is D, the horizontal coordinate of the reference element 450 is Sx, and the horizontal coordinate of the selection element 460 corresponding to the reference element 450 is Cx, the calculation unit 121 calculates the difference (Sx−Cx) between the horizontal coordinates of the left and right images as the disparity value (D).

Besides the above-described manner, the calculation unit 121 may calculate the disparity value in an alternative manner. For example, the calculation unit 121 calculates the global disparity value between the reference element 450 and the selection element 460 a plurality of times using a binocular disparity model, and adopts the calculated global disparity value as the disparity value. Alternatively, the calculation unit 121 aligns the reference element 450 with the selection element 460, averages the disparity values of respective pixels inside the aligned elements, and adopts the average as the disparity value. Alternatively, the calculation unit 121 aligns the reference element 450 with the selection element 460, selects a pixel lying at the center of the aligned elements, calculates the disparity between the selected pixel and other pixels, and adopts the calculated disparity as the disparity value.

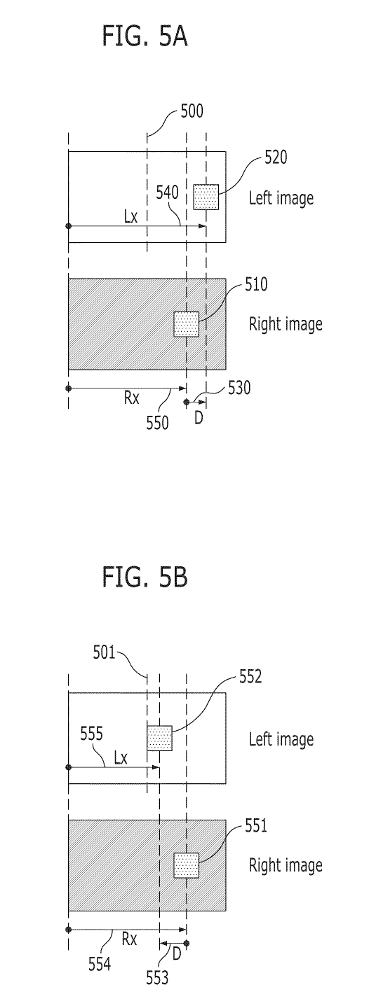

As such, the calculation unit 121 calculates the disparity value in the above-mentioned manners and, in order to obtain a more precise disparity value, applies the above-mentioned manners to the calculated disparity value again. The obtained disparity value has a size or sign (±), so that the determination unit 122 identifies the disparity value with regard to a predetermined reference value to determine whether the 3D image is reversed or not. The reference value 420, 450 varies according to whether the reference element exists in the left or right image. The process of determining whether the 3D image is reversed or not based on the disparity value will now be described in more detail with reference to FIGS. 5A and 5B.

FIGS. 5A and 5B illustrate a process of determining whether a 3D image is reversed or not by an apparatus for displaying 3D images in a 3D image system in accordance with an embodiment of the present invention. Specifically, FIG. 5A corresponds to a case of determined by the determination unit 122 that a 3D image is not reversed based on a disparity value, and FIG. 5B shows a case of determined by the determination unit 122 that a 3D image is reversed based on a disparity value.

Referring to FIG. 5A, as above-described, the calculation unit 121 selects an image (e.g. left image) among the left and right images, determines a reference element 520 in the selected left image, determines a selection element 510 corresponding to the reference element 520 in the non-selected right image. Also, as another embodiment of the present invention, the calculation unit 121 divides the selected left image with reference to the center axis 500 into first and second separate images, determines the reference element 520 in a separate image, e.g. the second separate image among the separate images, and determines the selection element 510 corresponding to the reference element 520 in the non-selected right image.

The calculation unit 121 calculates the disparity value between the reference element 520 and the selection element 510. Assuming that the horizontal coordinate of the reference element 520 is Lx 540, the horizontal coordinate of the selection element 510 is Rx 550, and the disparity value is D, the calculation unit 121 defines the difference (Lx−Rx) between the horizontal coordinates of the left and right images as the disparity value (D).

The determination unit 122 compares the disparity value with a predetermined reference value to determine whether the 3D image is reversed or not. The disparity value has a sign, therefore the determination unit 122 determines whether the 3D image is reversed or not based on the sign of the disparity value.

For example, when the disparity value is larger than the reference value (e.g. when the reference value is zero and thus the disparity value is a positive value), the 3D image does not need to be reversed. On the contrary, when the reference value is smaller than the reference value (e.g. when the disparity value is a negative value), the 3D image needs to be reversed. The disparity value in FIG. 5A, e.g. D 530, is larger than the reference value (and thus is a positive value), the 3D image of FIG. 5A does not need to be reversed.

Referring to FIG. 5B, as above-described, the calculation unit 121 selects an image (e.g. left image) among the left and right images, determines a reference element 552 in the selected left image, determines a selection element 551 corresponding to the reference element 552 in the non-selected right image. Also, as another embodiment of the present invention, the calculation unit 121 divides the selected left image with reference to the center axis 501 into first and second separate images, determines the reference element 552 in a separate image, e.g. the second separate image among the separate images, and determines the selection element 551 corresponding to the reference element 552 in the non-selected right image.

The calculation unit 121 calculates the disparity value between the reference element 552 and the selection element 551. Assuming that the horizontal coordinate of the reference element 552 is Lx 555, the horizontal coordinate of the selection element 551 is Rx 554, and the disparity value is D, the calculation unit 121 defines the difference (Lx−Rx) between the horizontal coordinates of the left and right images as the disparity value (D).

The determination unit 122 compares the disparity value (D) 553 with a predetermined reference value to determine whether the 3D image is reversed or not. The disparity value has a sign, therefore the determination unit 122 determines whether the 3D image is reversed or not based on the sign of the disparity value based on the sign of the disparity value.

For example, when the disparity value is larger than the reference value (e.g. when the reference value is zero and thus the disparity value is a positive value), the 3D image does not need to be reversed. On the contrary, when the reference value is smaller than the reference value (e.g. when the disparity value is a negative value), the 3D image needs to be reversed. The disparity value in FIG. 5B, e.g. D 530, is small than the reference value (and thus is a negative value), the 3D image of FIG. 5A needs to be reversed.

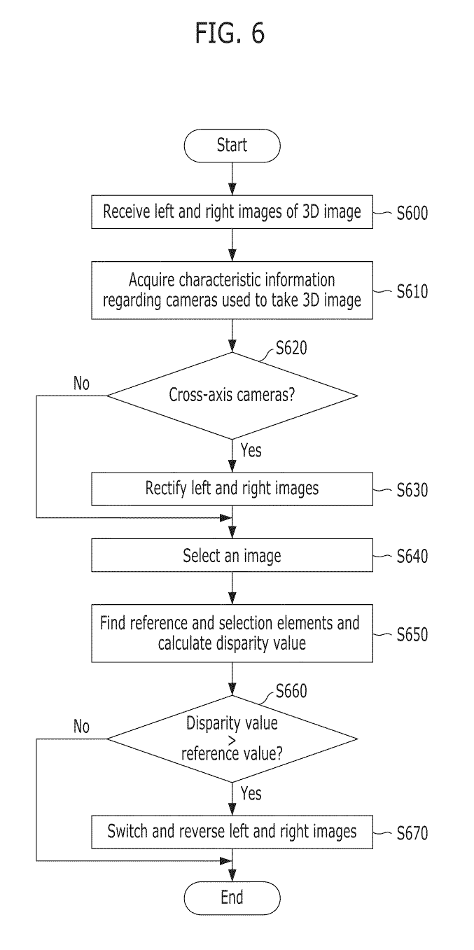

After the determination unit 122 determines whether the 3D image is reversed or not based on the disparity value, the correction unit 130 receives the determination result from the determination unit 122, and corrects the left and right images of the 3D image based on the determination result. More specifically, the correction unit 130 stores each of the left and right images in a buffer. When it has been determined that the 3D image needs to be reversed, the correction unit 130 switches positions of the left and right images to correct the reversed 3D image. When it has been determined that the 3D images does not need to be reversed, the correction unit 130 outputs the inputted left and right images without modification. A process of displaying a 3D image in a 3D image system in accordance with an embodiment of the present invention will now be described in more detail with reference to FIG. 6.

FIG. 6 schematically illustrates a process of displaying a 3D image by an apparatus for displaying 3D images in a 3D image system in accordance with an embodiment of the present invention.

Referring to FIG. 6, the 3D image display apparatus receives left and right images taken by a plurality of cameras and stores each of the images at step 5600. Besides the cameras, other various types of imaging devices may be employed to obtain the left and right images. The 3D image display apparatus acquires the characteristic information of the imaging devices, which take the left and right images, by extracting the characteristic information from the left and right images, or acquires the characteristic information of the imaging devices in the additional information, when the 3D image display apparatus separately receives the additional information regarding camera characteristics, etc. from the outside to obtain information regarding the cameras at step 5610. Herein, the 3D image display apparatus can acquire the characteristic information by extracting not only using the horizontal disparity of the left and right images, but also using various types of algorithms other than the horizontal disparity-based algorithm.

The 3D image display apparatus determines whether to rectify the left and right images or not based on the characteristic information regarding the cameras used to take the left and right images at step 5620. When cross-axis cameras have been used to take the left and right images, the 3D image display apparatus rectifies the left and right images using a rectification algorithm, such as a homography algorithm or an affine algorithm, at step 5630. The process of rectifying the left and right images has already been described in detail with reference to FIG. 2, and repeated description thereof will be omitted herein.

The 3D image display apparatus selects an image among the left and right images at step 5640. It will be assumed for convenience of description that the right image is selected. The 3D image display apparatus determines a reference element in the selected right image, determines a selection element corresponding to the reference element in the non-selected left image, and then calculates the disparity value between the left and right images by using the reference element and the selection element at step S650.

Also, as another embodiment of the present invention, the 3D image display apparatus selects an image, e.g. the right image, determines a center axis vertically extending through the horizontal center in the selected right image, and divides the selected right image with reference to the center axis at step 5640. Besides the above-mentioned manner of dividing the image, the 3D image display apparatus can divide the image in various other manners, i.e. divide the image with reference to a center axis, at which the disparity of both images is zero.

The 3D image display apparatus determines the reference element in a separate image among the first and second separate images divided the right image, determines the selection element corresponding to the reference element in the non-selected left image, and calculates the disparity value between the left and right images by using the reference element and the selection element at step S650. The process of calculating the disparity value has already been described in detail, and repeated description thereof will be omitted herein.

The 3D image display apparatus compares the disparity value with a reference value at step 5660. As based on the result of the comparison at step 5660, when the disparity value is larger than the reference value, the 3D image display apparatus switches the left and right images of the 3D image so that the reversed 3D image is corrected at step S670. More specifically, the 3D image display apparatus stores each of the left and right images in a buffer and, when the determination requires that the 3D image be reversed by the correction based on the result of the comparison, switches positions of the left and right images to correct the reversed 3D image.

As based on the result of the comparison at step 5660, when the disparity value is smaller than the reference value, i.e. when the 3D image does not need to be reversed by the correction, the 3D image display apparatus displays the stored left and right images. The disparity value has a size or sign, so that the 3D image display apparatus can identify the disparity value with regard to a predetermined reference value to determine whether the 3D image is reversed or not. The reference value varies according to which part of the left or right image the reference element belongs to. For example, when the disparity value is smaller than the reference value (e.g. when the reference value is zero and thus the disparity value is a negative value), the 3D image does not need to be reversed. On the contrary, when the reference value is larger than the reference value (e.g. when the disparity value is a positive value), the 3D image needs to be reversed.

In accordance with the exemplary embodiments of the present invention, it is determined in a 3D image system whether a 3D image is normal or not, e.g. whether left and right images of the 3D image are reversed or not, so that the 3D image is displayed correctly to the watcher. Furthermore, after determining whether the 3D image is reversed or not, reversing of the 3D image is automatically corrected so that the watcher has the perception of depth from the correctly displayed 3D image.

While the present invention has been described with respect to the specific embodiments, it will be apparent to those skilled in the art that various changes and modifications may be made without departing from the spirit and scope of the invention as defined in the following claims.

What is claimed is:

1. An apparatus for displaying 3D image display in a 3D image system, comprising:
a receiving unit configured to receive left and right images taken by a plurality of imaging devices;
a calculation unit configured to select an image among the left and right images, determine a reference element in the selected image, determine a selection element corresponding to the reference element in the non-selected image, and calculate a disparity value between the left and right images by using the reference element and the selection element;
a determination unit configured to determine whether the left and right images are normal or not by using the disparity value; and
a correction unit configured to correct the left and right images based on the determination result.

2. The apparatus of claim 1, further comprising an acquisition unit configured to acquire characteristic information regarding the imaging devices from the left and right images, or acquire the characteristic information in additional information, when the receiving unit separately receives the additional information from an outside.

3. The apparatus of claim 2, further comprising a rectification unit configured to determine whether the left and right images have been taken by cross-axis imaging devices based on the characteristic information, and rectify the left and right images based on the determination result.

4. The apparatus of claim 3, wherein the rectification unit is configured to rectify the left and right images by projecting the left and right images onto two parallel planes, when it is confirmed based on the characteristic information that the left and right images have been taken by the cross-axis imaging devices.

5. The apparatus of claim 1, wherein the calculation unit is configured to divide the selected image with reference to a center axis, which vertically extends through a horizontal center of the selected image or has disparity values of the left and right images being zero, and determine the reference element in an image among the divided images.

6. The apparatus of claim 1, wherein the reference element comprises at least one pixel selected from the group consisting of a pixel corresponding to a predetermined region in the selected image, a pixel chosen by a predetermined criterion, and a pixel chosen randomly.

7. The apparatus of claim 6, wherein the calculation unit is configured to determine a pixel corresponding to the reference element in the non-selected image as the selection element.

8. The apparatus of claim 1, wherein the calculation unit is configured to calculate a difference between coordinate values of the reference element and the selection element as the disparity value.

9. The apparatus of claim 1, wherein the determination unit is configured to compare the disparity value with a predetermined reference value, and determine that the left and right images are reversed, when it is confirmed from the comparison result that the disparity value is smaller than the reference value.

10. The apparatus of claim 9, wherein the determination unit is configured to determine that the left and right images are not reversed, when it is confirmed from the comparison result that the disparity value is larger than the reference value.

11. The apparatus of claim 10, wherein the correction unit is configured to correct reversing of the 3D image by switching positions of the left and right images using a buffer, when it is confirmed from the determination result that the left and right images need to be reversed.

12. The apparatus of claim 10, wherein the correction unit is configured to output the left and right images, when it is confirmed from the determination result that the left and right images do not need to be reversed.

13. A method for displaying 3D image display in a 3D image system, comprising:
selecting an image among left and right images taken by the imaging devices;
determining a reference element in the selected image, and determining a selection element corresponding to the reference element in the non-selected image;
calculating a disparity value between the left and right images by using the reference element and the selection element;
determining whether the left and right images are normal or not by using the disparity value; and
correcting the left and right images based on the determination result.

14. The method of claim 13, further comprising:
acquiring characteristic information regarding a plurality of imaging devices from the left and right images, or acquiring the characteristic information in additional information, when the additional information is separately received from an outside; and
determining whether the left and right images have been taken by cross-axis imaging devices based on the characteristic information, and rectifying the left and right images based on the determination result.

15. The method of claim 13, wherein, the determining of the reference element divides the selected image with reference to a center axis, which vertically extends through a horizontal center of the selected image or has disparity values of the left and right images being zero, and determines the reference element in an image among the divided images.

16. The method of claim 13, wherein, the determining of the selection element determines a pixel corresponding to the reference element in the non-selected image as the selection element;
wherein the reference element comprises at least one pixel selected from the group consisting of a pixel corresponding to a predetermined region in the selected image, a pixel chosen by a predetermined criterion, and a pixel chosen randomly.

17. The method of claim 13, wherein, the calculating of the disparity value calculates a difference between coordinate values of the reference element and the selection element as the disparity value.

18. The method of claim 13, wherein the determining of the left and right compares the disparity value with a predetermined reference value, and determines that the left and right images are reversed, when it is confirmed from the comparison result that the disparity value is smaller than the reference value, determines that the left and right images are not reversed, when it is confirmed from the comparison result that the disparity value is larger than the reference value.
